(19) United States
(12) Patent Application Publication
(10) Pub. No.: US 2014/0292848 A1
(43) Pub. Date: Oct. 2, 2014

(54) RECORDING APPARATUS, AND METHOD OF ADJUSTING POSITION OF RECORDING UNIT IN RECORDING APPARATUS

(71) Applicant: Brother Kogyo Kabushiki Kaisha, Nagoya-shi (JP)

(72) Inventor: Kohei TERADA, Kiyosu-shi (JP)

(73) Assignee: Brother Kogyo Kabushiki Kaisha, Nagoya-shi (JP)

(21) Appl. No.: 14/190,201

(22) Filed: Feb. 26, 2014

(30) Foreign Application Priority Data
Mar. 28, 2013 (JP) 2013-068138

(51) Int. Cl. B41J 2/07

(52) U.S. Cl. CPC B41J 2/07
USPC 347/9

(57) ABSTRACT

A recording apparatus according to a first aspect of the invention comprises a recording unit, a first adjuster, and a second adjuster. The recording unit is configured to record an image on a recording medium, and includes an opposing face to face the recording medium at a time of recording an image on the recording medium. The firs adjuster is configured to rotate a first position and a second position different from the first position, about a first axis perpendicular to the opposing face. The first and second positions are defined on the recording unit. The second adjuster is configured to rotate the first position and the second position about a second axis, different from the first axis, perpendicular to the opposing face.

### CROSS REFERENCE TO RELATED APPLICATION

This application claims priority from Japanese Patent Application No. 2013-068138, which was filed on Mar. 28, 2013, the disclosure of which is herein incorporated by reference in its entirety.

### BACKGROUND OF THE INVENTION

1. Field of the Invention

The present invention relates to a recording apparatus configured to record an image to a recording medium, and a method of adjusting the position of a recording unit in the recording apparatus.

2. Description of Related Art

Regarding a method of adjusting the position of a recording unit in the recording apparatus, there has been known a technology which adjusts the position of the recording unit by individually performing a process of moving the recording unit in a direction about an axis (hereinafter, “rotational direction”) perpendicular to an opposing face of the unit and a process of moving of the same in a direction parallel to the opposing face (hereinafter, “parallel direction”).

### SUMMARY OF THE INVENTION

However, in order to accurately adjust the position with the structure which individually performs the process of moving the recording unit in the rotational direction and the process of moving the same in the parallel direction, the movement in the rotational direction and the movement in the parallel direction need to be independent of each other. In other words, at least one of the following requirements needs to be met: movement in the rotational direction does not cause movement in the parallel direction; and movement in the parallel direction does not cause the movement in the rotational direction. Restricting the movement of the recording unit in the rotational direction while moving the same in the parallel direction necessitates a large-scale mechanism, because the entire mechanism for moving the recording unit in the rotational direction needs to be moved in the parallel direction. The same applies when moving, in the rotational direction, the entire mechanism for moving the recording unit in the parallel direction, and a large-scale mechanism will be necessary.

Further, in order to accurately adjust the position with the structure which individually performs the process of moving the recording unit in the rotational direction and the process of moving the same in the parallel direction, one of the movements in the rotational direction and in the parallel direction need to be adjusted after the other one of the movements, affecting the one of the movements, is adjusted. In other words, test recording is first conducted to determine a target travel amount (where “target travel amount” means an amount by which an object is moved (i.e., a distance between the current position and a target position where the object should he disposed). The same definition applies to the rest of the description hereinbelow) in the rotational direction, and then recording unit is moved in the rotational direction, after which another test recording is conducted to determine the target travel amount in the parallel direction and moving the recording unit in the parallel direction. Alternatively, the test recording is conducted to determine the target travel amount in the parallel direction, and then the recording unit is moved in the parallel direction, after which another test recording is conducted to determine the target travel amount in the rotational direction, and then the recording unit is moved in the rotational direction. In either cases, a complex

It is therefore an object of the present invention to provide a recording apparatus capable of accurate position adjustment with a simple process and structure, and to provide a method of adjusting the position of a recording unit in the recording apparatus.

A recording apparatus according to a first aspect of the invention comprises a recording unit, a first adjuster, and a second adjuster. The recording unit is configured to record an image on a recording medium, and includes an opposing face to face the recording medium at a time of recording an image on the recording medium. The first adjuster is configured to rotate a first position and a second position different from the first position, about a first axis perpendicular to the opposing face. The first and second positions are defined on the recording unit. The second adjuster is configured to rotate the first position and the second position about a second axis, different from the first axis, perpendicular to the opposing face.

A method of adjusting a position of a recording unit in a recording apparatus according to a second aspect of the invention comprises first to fourth processes. The recording apparatus includes a recording unit, a first adjuster, and a second adjuster. The recording unit is configured to record an image on a recording medium, and includes an opposing face to face the recording medium at a time of recording an image on the recording medium. The first adjuster is configured to rotate a first position and a second position different from the first position, about a first axis perpendicular to the opposing face. The first and second positions are defined on the recording unit. The second adjuster is configured to rotate the first position and the second position about a second axis, different from the first axis, perpendicular to the opposing face. The first process is of measuring a relative position which is a position of the recording unit relative to a position where the recording unit should be disposed in the recording apparatus. The second process is of after the first process, determining a target travel amount relative to a direction parallel to the opposing face of the recording unit, based on the relative position measured in the first process. The third process is of after the first process, determining a first operation quantity which is an operation quantity of the first adjuster, and a second operation quantity which is an operation quantity of the second adjuster, based on the target travel amount determined in the second process. The fourth process is of, after the third process, operating the first adjuster and the second adjuster based on the first operation quantity and the second operation quantity, to cause the recording unit to move in the direction parallel to the opposing face by the target travel amount.

### BRIEF DESCRIPTION OF THE DRAWINGS

Other and further objects, features and advantages of the invention will appear more fully from the following description taken in connection with the accompanying drawings in which:

FIG. 1 is a schematic side view showing the inside of an ink-jet printer related to an embodiment of the present invention.

FIG. 2 is a plan view showing a structure of an ink-jet head of the printer shown in FIG 1.

FIG. 3A is a schematic plan view showing a position adjusting mechanism for a head unit before adjustment.

FIG. 3B is a schematic plan view of a position adjusting mechanism for the head unit after adjustment.

FIG. 4 is a block diagram showing electric structure of the printer shown in FIG. 1.

FIG. 5 is a flow chart showing a position adjustment method for the printer shown in FIG. 1.

FIG. 6 is a flow chart showing an ejection timing adjustment method for the printer shown in FIG. 1.

FIG. 7 is a diagram showing an exemplary application of the present invention to a serial inkjet printer.

### DESCRIPTION OF THE PREFERRED EMBODIMENTS

The following describes a preferable embodiment of the present invention with reference to the attached drawings.

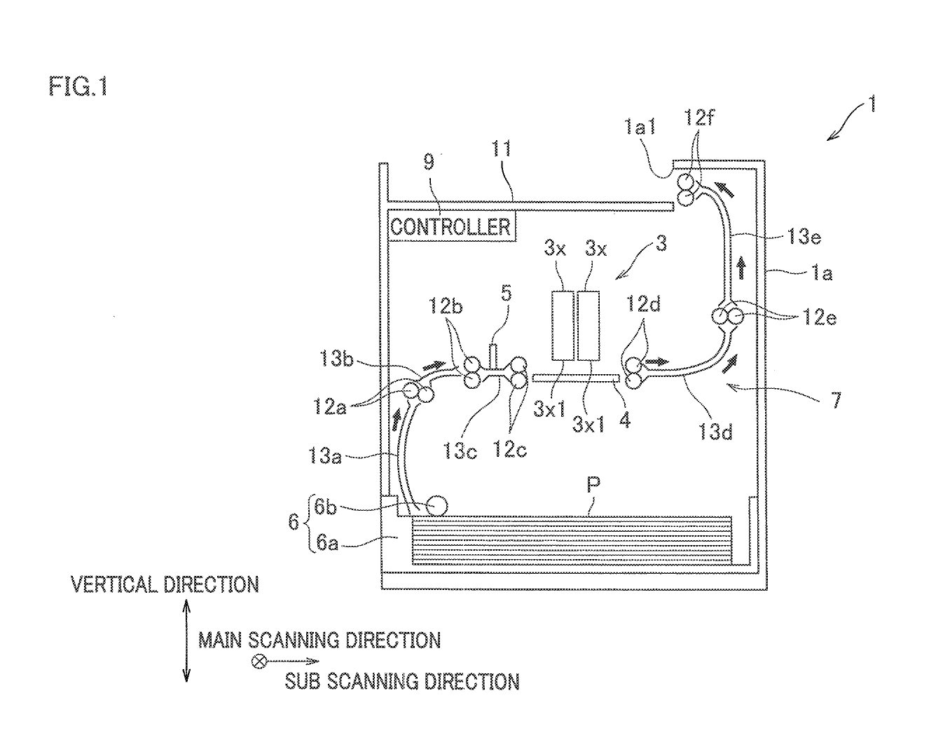

First, with reference to FIG. 1, an overall structure of an inkjet printer 1 related to one embodiment of the present invention is described.

The printer 1 includes a casing la having a rectangular parallelepiped shape. In a top part of the top plate of the casing la is provided a sheet output unit 11. The casing 1a accommodates therein an inkjet head 3, a platen 4, a sheet sensor 5, a sheet-feeder unit 6, a conveyance unit 7, and a controller 9, and the like. Further, in the inside space of the casing 1a, there is a conveyance path through which a sheet P as an example of the recording medium of the invention is conveyed from the sheet-feeder unit 6 to the sheet output unit 11 in a direction indicated by the bold arrow of FIG. 1.

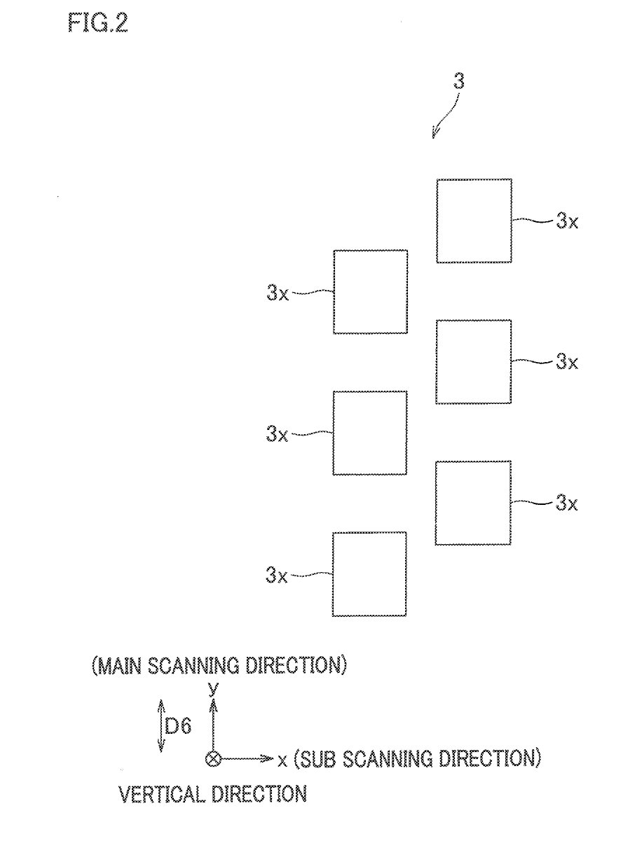

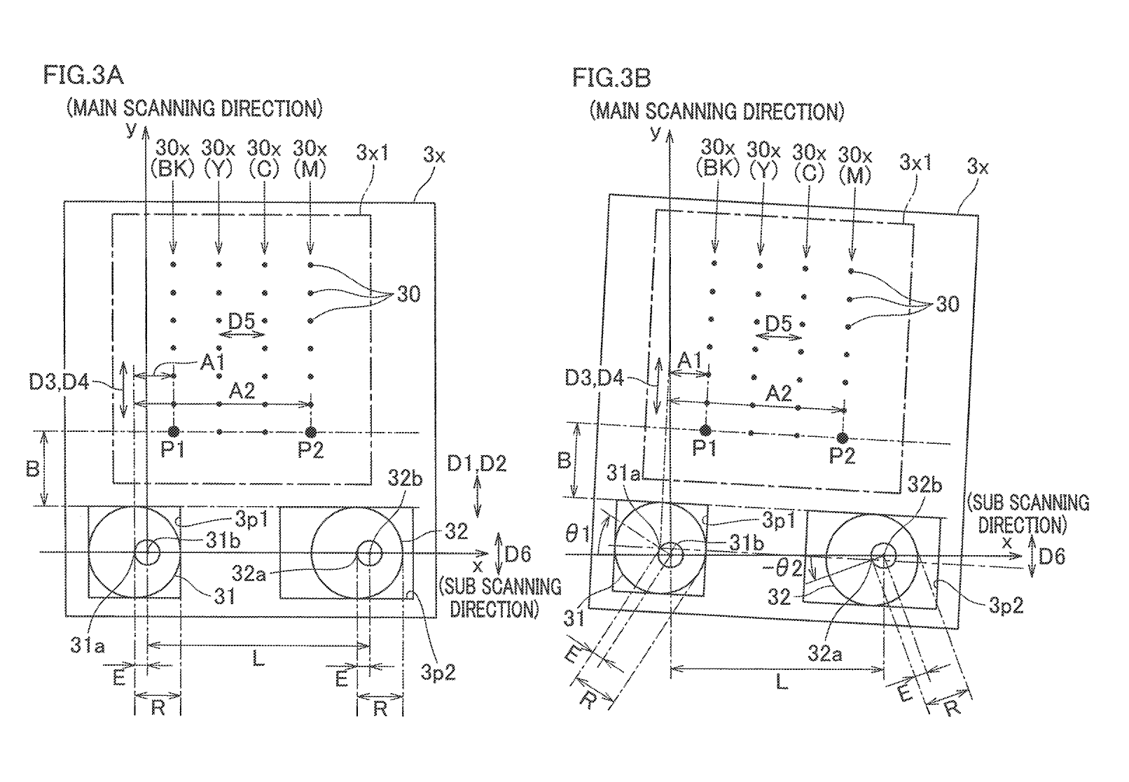

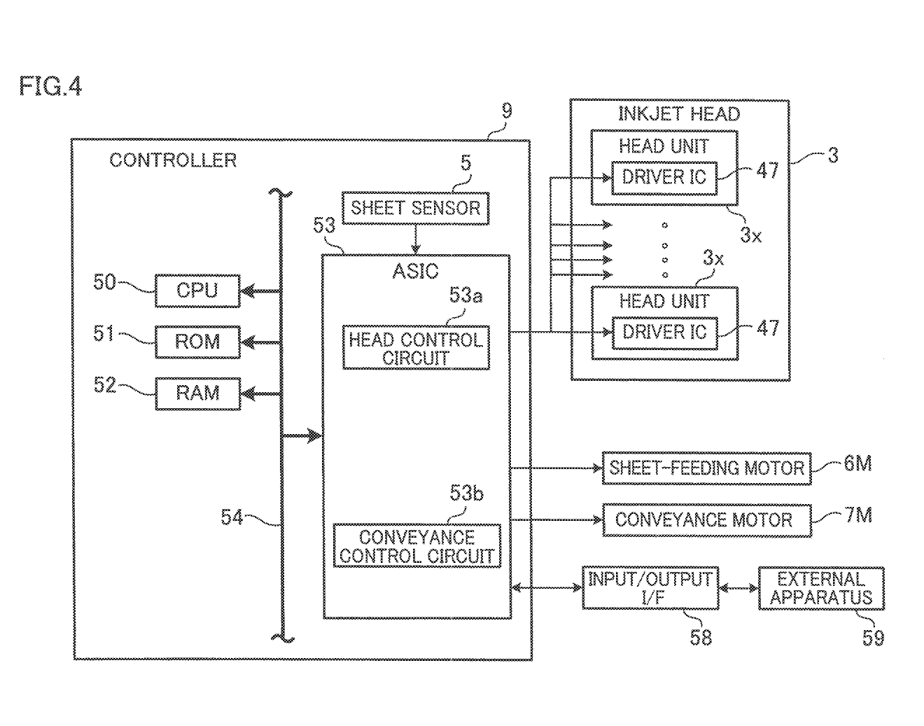

The head 3 includes six head units 3x which are examples of the recording units of the present invention. The head units 3x are apart from each other and aligned in a main scanning direction, in a zigzag manner (see FIG. 2). A direction in which the head units 3x are arranged (sixth direction D6) is parallel to an opposing face 3x1 of each head unit 3x (see FIG. 1: the surface to face the sheet P at a time of recording), and perpendicularly crosses a direction (sub scanning direction) in which the head unit 3x and sheet P move relatively to each other at the time of recording. In the present embodiment, the sixth direction D6 is the main scanning direction (a direction parallel to the opposing face 3x1 and perpendicularly crossing the directions of the relative movement: lateral direction of the sheet). The printer 1 is a line type printer which performs recording while its head units 3x are fixed. The six head units 3x each has the same structure, and includes a passage member, an energy applier, and a driver IC 47 (see FIG. 4). In the passage member are formed passages leading to ejection openings 30 (see FIG. 3A and FIG. 3B). The energy applier is configured to apply to the ink inside the passages energy for ejection of the ink from the ejection openings 30. The present embodiment adopts a piezoelectric energy applier (piezoelectric actuator) using a piezoelectric element. The piezoelectric actuator is connected to the controller 9 via a wiring member (e.g., flexible printed circuit board: FPC) having a driver IC 47 mounted thereon. Under control of the controller 9, a predetermined electric potential is given from the driver IC 47 to drive the piezoelectric actuator.

The platen 4 is a member in the form of a flat plate. The platen 4 faces the six head units 3x in the vertical direction. The vertical direction is perpendicularly crossing the main scanning direction and the sub scanning direction. Between the top surface of the platen 4 and the opposing face 3x1 of each of the head units 3x is a predetermined gap suitable for recording (image formation).

The sheet sensor 5 is disposed upstream of the head 3, relative to a direction of conveying the sheet P by the conveyance unit 7 (hereinafter, simply referred to as “conveyance direction”). The sheet sensor 5 detects the leading end of the sheet P and transmits a detection signal to the controller 9.

The sheet-feeder unit 6 includes a sheet-feeder tray 6a and a sheet-feeding roller 6b. The sheet-feeder tray 6a is detachable with respect to the casing 1a. The sheet-feeder tray 6a is a box with its top surface being opened, and is capable of accommodating a plurality of sheets R Driving the sheet-feeding motor 6M (see FIG. 4) under control of the controller 9 rotates the sheet-feeding roller 6b, thus feeding the uppermost one of the sheets P from the sheet-feeder tray 6a.

The conveyance unit 7 includes pairs of rollers 12a, 12b, 12c, 12d, 12e, and 12f, and guides 13a, 13b, 13c, 13d, and 13e. The roller pairs 12a to 12f are disposed along the conveyance path, sequentially in this order from the upstream relative to the conveyance direction. One roller out of each roller pairs 12a to 12f is a drive roller rotated by driving the conveyance motor 7M (see FIG. 4) under control of the controller 9. The other one of each pair is a driven roller which rotates with rotation of the corresponding drive roller. The guides 13a to 13e disposed along the conveyance path, sequentially from the upstream relative to the conveyance direction, are alternated with the roller pairs 12a to 12f. Each of the guides 13a to 13e is made of a pair of plates disposed to face each other.

Under the control by the controller 9, the sheet P feeded from the sheet-feeder unit 6 is sandwiched by the roller pairs 12a to 12f and conveyed in the conveyance direction, through the space between the plates of the guides 13a to 13e. When the sheet P passes immediately under each head unit 3x while being supported by the top surface of the platen 4, ink is ejected from a plurality of ejection openings 30 (see FIG. 3A and FIG. 3B) formed on the opposing face 3x1 of each head unit 3x towards the surface of the sheet P, under control of the controller 9. The ink ejection is performed from the ejection openings 30 based on the detection signals transmitted from the sheet sensor 5. The sheet P on which an image is formed is discharged to the sheet output unit 11 from an opening 1a1 formed at a top part of the casing 1a.

As shown in FIG. 4, the controller 9 includes a CPU (Central Processing Unit) 50, a ROM (Read Only Memory) 51, a RAM (Random Access Memory) 52, an ASIC (Application Specific Integrated Circuit) 53, a path 54, and the like. The ROM 51 stores therein a program run by the CPU 50, various fixed data, and the like. The RAM 52 temporarily stores data needed at a time of running the program (image data or the like). The ASIC 53 includes a head control circuit 53a and a conveyance control circuit 53b. Further, the ASIC 53 is connected to and in communication with an external apparatus 59 such as a PC (Personal Computer) through an input/output I/F (Interface) 58. The head control circuit 53a controls the driver IC 47 based on record data input from the external apparatus 59. The conveyance control circuit 53b controls the sheet-feeding motor 6M and the conveyance motor 7M based on the record data input from the external apparatus 59.

Next, with reference to FIG. 3A and FIG. 3B, the following describes how the ejection openings 30 are disposed on each head unit 3x, and a position adjusting mechanism of the head unit 3x. Note that the ejection openings 30 are disposed in the same way for all of the six head units 3x, and the structure of the position adjusting mechanism is also the same for the head units 3x. Therefore, FIG. 3A and FIG. 313 shows a single head unit 3x and a position adjusting mechanism provided related to that head unit 3x.

The ejection openings 30 on the opposing face 3x1 are aligned in the fourth direction D4 at predetermined intervals, and form four ejection opening arrays 30x corresponding to ink of Black (BK), Yellow (Y), Cyan (C), and Magenta (M), respectively. The four ejection opening arrays 30x are aligned in a fifth direction D5 which is parallel to the opposing face 3x1 and perpendicularly crosses the fourth direction D4, at predetermined intervals.

The position adjusting mechanism includes a first cam 31 as an example of the first adjuster of the invention and a second cam 32 as an example of the second adjuster of the invention. The cams 31 and 32 have structures and the sizes which are identical to each other. The cams 31 and 32 are disposed in such a manner as to sandwich therebetween the four ejection opening arrays 30x relative to the fifth direction D5. The cams 31 and 32 are provided through holes 3p1 and 3p2 formed on the head unit 3x, and are structured to rotate with their circumferential surfaces being in contact with the surfaces defining the through boles 3p1 and 3p2 of the head unit 3x, respectively. The cams 31 and 32 have rotation centers 31b and 32b which deviate from the centers 31a and 32a by a distance F, respectively. The rotation center 31b is an example of the second axis of the invention. The rotation center 32b is an example of the first axis of the invention. Shafts serving as the rotation centers 31b and 32b extend in a direction perpendicularly crossing the opposing face 3x1, and are supported by the casing 1a. The through hole 30, when viewed from the vertical direction, has a square shape with each side having substantially the same length as the diameter of the first cam 31. The through hole 3p2 on the other hand has a rectangular shape with two sides having substantially the same length as the diameter of the second cam 32 extended in the fourth direction D4, and with two sides longer than the diameter of the second cam 32 extended in the fifth direction D5, when viewed from the vertical direction. Therefore, while the movement of the first cam 31 is restricted in both the fourth direction D4 and the fifth direction D5, the movement of the second cam 32 is restricted to the fourth direction D4, but not in the fifth direction D5, and is free relative to the fifth direction D5. The cams 31 and 32 are coupled with not-shown gears and not-shown arms, respectively, and each teeth of the gears rotates the corresponding cam by a predetermined angle. The gears also serve as a lock, and fixing the gear inhibits rotation of the corresponding one of the cams 31 and 32.

A first position P1 and a second position P2 are any given positions designated on the head unit 3x. In this embodiment, the centers of the ejection openings 30 in the ejection opening arrays 30x corresponding to Black (BK) and Magenta (M), which are positioned closest to the cams 31 and 32 relative to the fourth direction D4 are the first position P1 and the second position P2, respectively. From the state shown in FIG. 3A, the cams 31 and 32 are assumed to he brought into the state shown in FIG. 3B, by rotating them clockwise by θ1 and −θ2, respectively. In this case, the amounts of travelling of the positions P1 and P2 relative to the main scanning direction are derived by the following Equation 1.

$$( \begin{matrix}Δ y 1 \\ Δ y 2\end{matrix} ) = \frac{E}{L} ( \begin{matrix}L - A 1 & - A 1 \\ L - A 2 & - A 2\end{matrix} ) ( \begin{matrix}Δ sin θ 1 \\ Δ sin θ 2\end{matrix} ) \qquad Equation 1$$

Definitions of each symbol in the above Equation 1 are as follows.

Δy1: the amount of travelling of the first position P1 relative to the main scanning direction

Δy2: the amount of travelling of the second position P2 relative to the main scanning direction

E: distance by which the cams 31 and 32 are deviated

R: radii of cams 31 and 32

L: distance between the rotation centers of the cams 31 and 32

B: intervals between the positions P1 and P2 and the cams 31 and 32, relative to the fourth direction D4

A1: interval between the first position P1 and the center 31a, relative to the fifth direction D5

A2: interval between the second position P2 and the center 31a, relative to the fifth direction D5

Δ sin θ1: the amount of variation of sin θ1 caused by varying θ1

Δ sin θ2: the amount of variation of sin θ2 caused by varying θ2

With rotation of the cams 31 and 32 about the rotation centers 31b and 32b, the positions P1 and P2 rotate. The first cam 31 rotates the positions P1 and P2 about the rotation center 32b, and the second cam rotates the positions P1 and P2 about the rotation center 31b. This way the position of each head unit 3x is adjustable. That is, with rotation of the positions P1 and P2 by the cams 31 and 32, the position of the head unit 3x is adjustable relative to travel including a component of travel in a direction perpendicularly crossing the opposing face 3x1 (hereinafter, “rotational direction”) and a component of travel in the fourth direction D4. Note that Δy1 and Δy2 are determined by both Δθ1 and Δθ2.

Where the direction perpendicularly crossing a line connecting the first position P1 and the second position P2 is third direction D3, the amount of travelling of the first position P1 by the first cam 31 in the third direction D3 is a, the amount of travelling of the second position P2 by the first cam 31 in the third direction D3 is b, the amount of travelling of the first position P1 by the second cam 32 in the third direction D3 is c, and the amount of travelling of the second position P2 by the second cam 32 in the third direction D3 is d, ad−bc≠0 (that is, there exists an inverse matrix (Equation 2 below) which is the inverse of the matrix of the above Equation 1). Note that Δθ1 and Δθ2 are determined by both Δy1 and Δy2.

$$( \begin{matrix}Δ sin θ 1 \\ Δ sin θ 2\end{matrix} ) = \frac{1}{E ( A 2 - A 1 )} ( \begin{matrix}A 2 & - A 1 \\ L - A 2 & - L + A 1\end{matrix} ) ( \begin{matrix}Δ y 1 \\ Δ y 2\end{matrix} ) \qquad Equation 2$$

The first direction D1 which is a direction corresponding to the line tangent to rotation about the rotation center 32b at the first position P1, and the second direction D2 which is the direction corresponding to the line tangent to rotation about the rotation center 31b at the second position P2 both include a component of fourth direction D4. The third direction D3 is the same direction as the sixth direction D6 (main scanning direction) before the position adjustment.

The first direction D1 and the second direction D2 are both preferably a direction close to the fourth direction D4 (substantially the same direction). Further, the first direction D1 and the second direction D2 are preferably a direction close to each other (substantially the same direction).

The closer the first direction D1 and the second direction D2 are to each other, the better the approximate accuracy of Equation 1. In other words, a difference between θ1 and θ2 determined based on the approximation equation assuming that the first direction D1 and the second direction D2 are the same direction and the rotation amounts θ1 and θ2 determined based on an exact formula is reduced, and the accuracy of the position adjustment is improved. Further, the closer the first direction D1 and the second direction D2 are, the greater the amount of travelling of the head unit 3x for the sizes of the cams 31 and 32. Therefore, with the first direction D1 and the second direction D2 being close to each other, downsizing of the printer 1 and highly accurate position adjustment become possible.

Note that, of the main scanning direction, the sub scanning direction, and the first to sixth directions D1 to D6, the main scanning direction and the sub scanning direction, and the sixth direction D6 are each a direction fixed with respect to the casing 1a, and is not varied when the head unit 3x rotates. To the contrary, the first direction D1 to fifth direction D5 are each a direction defined relative to the individual head units 3x, and are varied by rotation of the head unit 3x. In the present embodiment, D3=D4=D6=the main scanning direction, and D5=the sub scanning direction before the position adjustment (see FIG. 3A).

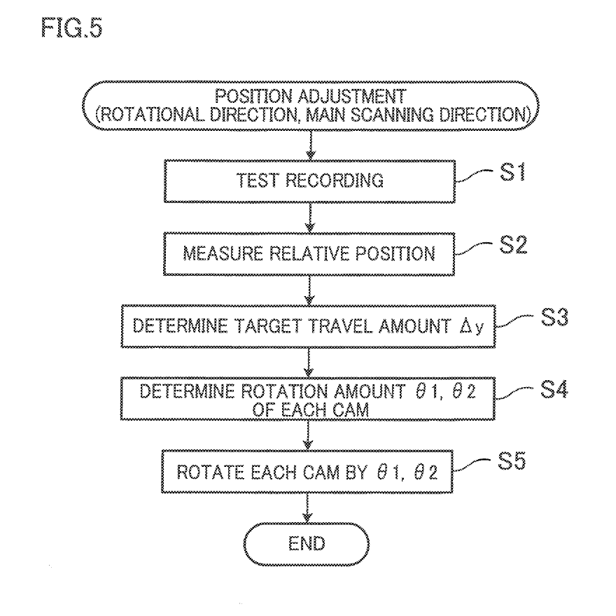

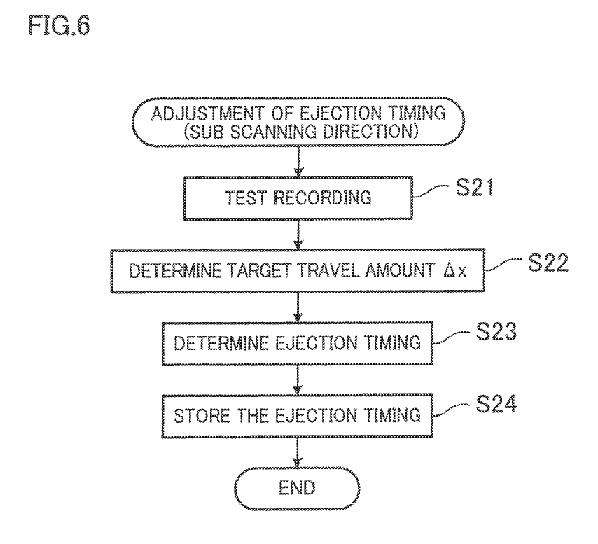

Next, with reference to FIG. 5 and FIG. 6, the following describes a position adjustment method and an ejection timing adjustment method for the head unit 3x.

The position adjustment is performed, for example, after each components of the printer 1 are assembled in the manufacturing process of the printer 1, before shipping of the printer 1 from the plant. The adjustment of ejection timing is performed after the position adjustment. Further, the position adjustment is performed relative to the rotational direction and the main scanning direction, and the adjustment of ejection timing is performed relative to the sub scanning direction.

In the position adjustment, test recording is first performed as shown in FIG. 5 (S1). Specifically, for each of the six head units 3x, ink is ejected from the ejection openings 30 corresponding to Black (BK) and Magenta (M) to perform recording on a test sheet P, and then the image recorded is read by using a scanner.

After S1, measurement is conducted as to a relative position (S2: first process). The relative position is a position of the head unit 3x relative to a position where the head unit 3x should be disposed in the printer 1. Specifically, based on the results of S1, the relative position is measured for each of the six head units 3x, from intervals relative to the main scanning direction between the landing position, on the sheet P, of the ink droplets ejected from the ejection openings 30 of one head unit 3x, and the landing position, on the sheet P, of the ink droplets ejected from the ejection openings 30 of another head unit 3x adjacent to the one head unit 3x relative to the main scanning direction.

After S2, Δy (target travel amount of the head unit 3x relative to the main scanning direction) is determined (S3: second process). Specifically, for each of the six head units 3x, Δy is determined based on the relative position measured in S2. By the “target travel amount”, it means an amount by which an object should travel (that is, an amount of travelling from the current position to a position where the object should be disposed).

After S3, the rotation amounts Δθ1 and Δθ2 of the cams 31 and 32 are determined (S4: third process). The rotation amount is an example of the operation quantity of the present invention. Δθ1 is an example of the first operation quantity of the present invention, and Δθ2 is an example of the second operation quantity of the present invention. Specifically, for each of the six head units 3x, Δ sin θ1 and Δ sin θ2 are derived, based on Δy determined in S3 and the above Equation 2, and rotation amounts Δθ1 and Δθ2 that result in such sines are determined. Note that the θ1 and θ2 are rotation amounts of the cams 31 and 32 with the sub scanning direction as the reference, and the Δθ1 and Δθ2 are variation in θ1 and θ2 of the cams 31 and 32 before and after movement in the position adjustment. In the present embodiment, θ1=0, and θ2=0 before the position adjustment. Therefore, θ1=Δθ1 and θ2=Δθ1.

After S4, the cams 31 and 32 are rotated clockwise by Δθ1 and Δθ2 (S5: fourth process). Specifically; for each of the six head units 3x, the arm is operated to rotate the gear by the number of tooth corresponding to the Δθ1 and Δθ2. This causes the positions P1 and P2 of each of the six head units 3x to move in the main scanning direction by Δy1 and Δy2. At this time, the six head units 3x may be moved at the same time or separately.

Note that, in the present embodiment, the rotation amounts θ1 and θ2 of the cams 31 and 32 are angles from the sub scanning direction (see FIG. 3B). The rotation amounts of the cams 31 and 32 for the head unit 3x are, in a precise mathematical sense, angles from a direction (the direction indicated by the single dotted line in FIG. 3B) connecting the centers 31a and 32a, and are slightly different from the θ1 and θ2 of the present embodiment; i.e., an amount resulting from subtraction of the entire rotation amount of the head unit 3x from θ1 and θ2 of the present embodiment. However, if a deviation distance E is sufficiently smaller than the distance between the rotation centers 31b and 32b, such a difference in Δθ1 and Δθ2 can be practically counted out.

Through the above processes, position adjustment is performed for each head unit 3x, relative to the rotational direction and the main scanning direction.

In adjustment of eject timing, test recording is first performed as shown in FIG. 6 (S21). Specifically, a pattern different from that used in S1 is used in the process similar to S1.

After S21, Δx (target travel amount of the landing position relative to the sub scanning direction) is determined (S22). Specifically, for each of the six head units 3x, based on the result of S21, Δx is determined, from intervals between landing position, on the sheet P, of the ink droplets ejected from the ejection openings 30 of one head unit 3x and the landing position, on the sheet P, of the ink droplets ejected from the ejection openings 30 of another head unit 3x adjacent to the one head unit 3x relative to the sub scanning direction, and from the distance from the landing position, on the sheet P, of the ink droplets ejected from the ejection openings 30 of the head unit 3x to an end of the sheet P relative to the sub scanning direction, and the like.

After S22, ink ejection timing from the ejection openings 30 is determined (S23). Specifically, ejection timing of ink is determined for each of the ejection openings 30 based on Δx determined in S22, and position information of the ejection opening 30 related to the fifth direction D5.

After S23, data related to the ejection timing determined in S23 is stored in the ROM 51, using a controller or the like of the manufacturing apparatus (S24). The controller 9 controls the ejection timing of the ink from the ejection openings 30 based on the data stored in the ROM 51, at a time of recording.

As hereinabove described, instead of individually performing movement in the rotational direction and that in the parallel direction to adjust the position, the present embodiment adjusts the position of the head units 3x by using the cams 31 and 32 to rotate the first position P1 and the second position P2 about the rotation centers 31b and 32b. That is, instead of perceiving the position adjustment of the head units 3x as a combination of movement in the rotational direction and that in the parallel direction, the present embodiment perceives the same simply as the movement of two predetermined points. i.e., positions P1 and P2 on each of the head units 3x, and collectively performs adjustment relative to both the rotational directions and the parallel direction (in the present embodiment, main scanning direction). This, as compared with adjustment based on the former perception, enables accurate position adjustment with a simple process and a simple structure, and complex processes or large-scale machines are not necessary.

The first direction D1 and the second direction D2 both include a component of the sub scanning direction. This enables position adjustment relative to the lateral direction (BR) of the sheet P. To add this, it is possible to minimize the rotation amount (adjustment range) of the cams 31 and 32 for the amount of movement of the head unit 3x relative to the lateral direction (BR) of the sheet P. Therefore, highly accurate position adjustment of the head unit 3x relative to the lateral direction (BR) of the sheet P is possible,

The printer 1 is structured so that ad−b≠0, where the direction perpendicularly crossing a line connecting the first position P1 and the second position P2 is third direction D3, the amount of travelling of the first position P1 by the first cam 31 in the third direction D3 is a, the amount of travelling of the second position P2 by the first cam 31 in the third direction D3 is h, the amount of travelling of the first position P1 by the second cam 32 in the third direction D3 is c, and the amount of travelling of the second position P2 by the second cam 32 in the third direction D3 is d. In this case, there will always be a combination of Δθ1 with Δθ, the position of each head unit 3x is reliably adjustable by the cams 31 and 32.

Adjusters for rotating the positions P1 and P2 of the head unit 3x include the cams 31 and 32 each of which rotates about an axis perpendicularly crossing the opposing face 3x1. It is therefore possible to realize highly accurate adjusters having little play, with a simple structure.

Further, the structures and the sizes of the cams 31 and 32 of the present embodiment are the same. The rotation amounts of the cams 31 and 32 are therefore determined with a more simple equation. To add this, since the identical components are used for the cams 31 and 32, it is possible to manufacture the printer 1 at a low cost.

Further, in the present embodiment, the rotation center 31b of the cam 31 corresponds to the axis of rotation of the cam 32, and the rotation center 32b of the cam 32 corresponds to the axis of rotation of the cam 31. The rotation center of the cam of one of the adjusters serves as an axis for the rotation of the entire printer 1 by means of the other adjuster. Therefore, unlike a case of separately providing a rotation center of a cam and the axis of rotation caused by an adjuster, each adjuster is realized with a simple structure.

The first direction D1 and the second direction D2 both include a component of the fourth direction (direction in which the ejection opening 30 are arranged) D4. Therefore, it is suitable for an inkjet liquid ejection apparatus such as the one described in the present embodiment.

The positions of each head unit 3x relative to the rotational direction and the fourth direction D4 are adjustable by rotation of the positions P1 and P2 with the use of the cams 31 and 32. The controller 9 controls the ejection timing of the ink from the ejection openings 30, based on positional information of the ejection openings 30 relative to the fifth direction D5. Since adjustment of the landing position relative to the fifth direction D5 does not require position adjustment by the cams 31 and 32 and the control of the ejection timing will cover the same, it is possible to simplify the processes and the structures related to the position adjustment.

The cams 31 and 32 are disposed in such a manner as to sandwich the four ejection opening arrays 30x therebetween, relative to the fifth direction D5. The greater the interval between the cams 31 and 32 relative to the fifth direction D5, the better the accuracy and efficiency of the position adjustment relative to the fourth direction D4 becomes (“efficiency” here means an amount of travelling of the head unit 3x for the rotation amounts of the cams 31 and 32). This improves the accuracy and the efficiency of the position adjustment relative to the fourth direction D4, while restraining an increase in the size.

The first direction D1 and the second direction D2 both include a component of the sixth direction (direction in which the six head units 3x are arranged) D6. The cams 31 and 32 are provided to each of the six head units 3x. For each of the six head units 3x, the S1 to S5 relating to the position adjustment are performed. In this case, a head 3 long in the sixth direction D6 is structured by using a plurality of head units 3x short in the sixth direction D6. Although this structure necessitates adjustment of the positional relation among the head units 3x, the position adjusting mechanism such as the one described in the present embodiment enables accurate position adjustment with a simple process and a simple structure.

Further, in the present embodiment, the centers 31a and 32a and the rotation centers 31b and 32b of the cams 31 and 32 are aligned in one row relative to the sub scanning direction, before adjustment (see FIG. 3A). This maximizes the amount of travelling of each head unit 3x relative to the main scanning direction, for the rotation amounts of the cams 31 and 32.

The above position adjustment may be performed for adjusting positional relation among components other than a recording unit in a recording apparatus (e.g., a cap for covering the opposing face), and application of the above position adjustment is not limited to one performed in a recording apparatus including a plurality of recording units for adjusting positional relation among the recording units.

The above position adjustment of the recording unit may be performed, for example, by a user of the recording apparatus, and the timing of performing the adjustment is not limited to the manufacturing process of the recording apparatus.

When adjusting the ejection timing, Δx may be determined without test recording, using the result of test recording performed in the position adjustment.

Confirmation of the result of test recording is not limited to one by means of an apparatus such as a scanner. For example, the result may be confirmed by using a microscope, or by human eyes.

In the above embodiment, an operation quantity of the adjuster is determined by using an approximation equation; however, the present invention is not limited to this. For example, the operation quantity of the adjuster may be determined by using an exact formula, or by using a table indicating an operation quantity of the adjuster and associated amount of travelling of the recording unit.

Although the first position and the second position are each set to the center of an ejection opening in the above-mentioned embodiment; however, these positions may be set to any given position other than the center of an ejection opening. In this case, a marking or the like for positioning may be given to the position.

The first adjuster and the second adjuster may be structured by a member other than a cam (e.g. screw).

The recording units do not have to be necessarily arranged in a zigzag manner, and may be arranged in one line or a in two or more lines in a non-zigzag manner. Further, the direction of arranging the recording units is not limited to the main scanning direction.

It is not necessary to provide a plurality of recording units in a recording apparatus, as long as the recording apparatus includes at least one recording unit.

The ejection openings on the opposing face may be altered in any given ways. For example, it is possible to align the openings in a single ejection opening array.

The above embodiment deals with a case where the liquid ejected from the ejection openings formed on the opposing face includes a plurality of kinds of liquids (e.g., ink of different colors such as Black, Yellow, and the like); however, the liquid to be ejected may be only a single kind of liquid (e.g. only Black ink, only Yellow ink, or the like). Further, the liquid is not limited to an ink, and may be any given liquid (e.g., a pretreatment liquid).

The energy applier is not limited to piezoelectric type adopting a piezoelectric element, and other type of energy applier may be adoptable (a thermal type adopting a heater element, an electrostatic type utilizing electrostatic force).

A recording apparatus related to the present invention is not limited to an inkjet type, and may be a laser type, a thermal transfer type, and the like.

The recording medium is not limited to a paper sheet. For example, in an intermediate transfer type, the recording medium is an intermediate transfer member (roller, belt, and the like).

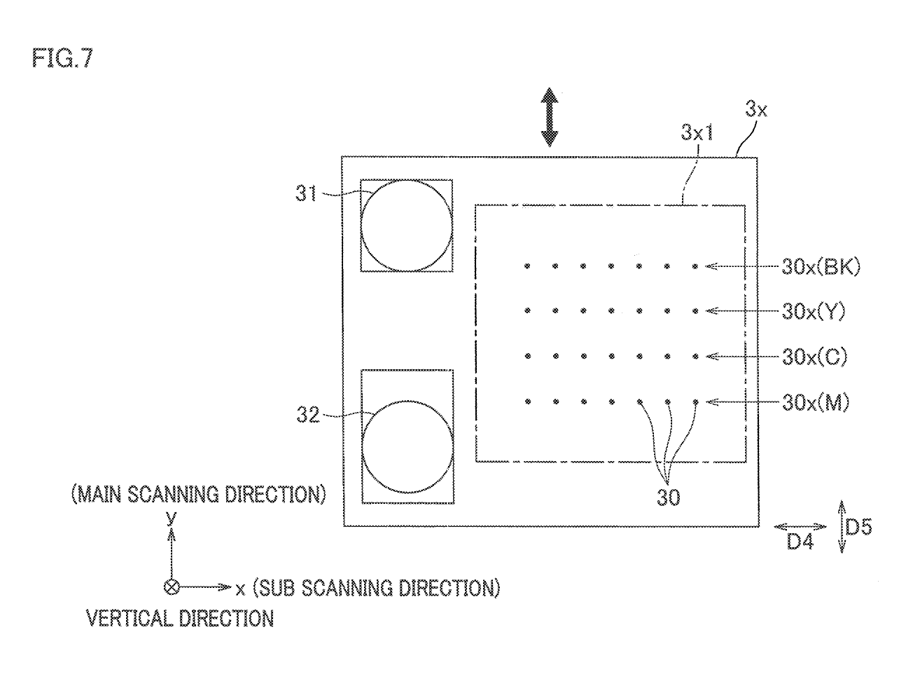

The recording apparatus of the present invention is not limited to a line type, and may be a serial type. When adopting the present invention to a serial inkjet printer, it is possible to adopt a structure as shown in, for example. FIG. 7, and adjust the head units 3x by using the cams 31 and 32. In the example shown in FIG. 7, the printer includes a single head unit 3x, and the head unit 3x ejects ink from its ejection openings 30 while moving in the main scanning direction, thereby recording an image on a sheet P.

The recording apparatus of the present invention is not limited to a printer, and may be a facsimile, a photocopier, and the like.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A recording apparatus, comprising:
a recording unit configured to record an image on a recording medium, which includes an opposing face to face the recording medium at a time of recording an image on the recording medium;
a first adjuster configured to rotate a first position and a second position different from the first position, about a first axis perpendicular to the opposing face, the first and second positions being defined on the recording unit; and
a second adjuster configured to rotate the first position and the second position about a second axis, different from the first axis, perpendicular to the opposing face.

2. The recording apparatus according to claim 1, wherein
a first direction which is a tangential direction to rotation of the first position about the first axis, and a second direction which is a tangential direction to rotation of the second position about the second axis each includes a component of direction parallel to the opposing face and perpendicular to a direction in which the recording unit and the recording medium move relatively to each other at a time of recording an image on the recording medium.

3. The recording apparatus according to claim 1, wherein
where a third direction is a direction perpendicular to a line jointing the first position and the second position,
a is an amount of travelling of the first position in the third direction, caused by the first adjuster,
b is an amount of travelling of the second position in the third direction, cause by the first adjuster,
c is an amount of traveling of the first position in the third direction, caused by the second adjuster, and
d is an amount of travelling of the second position in the third direction, caused by the second adjuster,
ab−bc≠0.

4. The recording apparatus according to claim 1, wherein
the first adjuster and the second adjuster each includes a cam which rotates about an axis perpendicular to the opposing face.

5. The recording apparatus according to claim 4, wherein
the cam of the first adjuster and the cam of the second adjuster have the same structure and the same size.

6. The recording apparatus according to claim 4, wherein
a rotation center of the cam of the first adjuster corresponds to the second axis, and
a rotation center of the cam of the second adjuster corresponds to the firs axis.

7. The reocrding apparatus according to claim 1, wherein
the opposing face includes a plurality of ejection openings from which a liquid is ejected,
the ejection openings are aligned in a fourth direction parallel to the opposing face to structure an ejection opening array, and
a first direction which is a tangential direction to rotation of the first position, and a second direction which is a tangential direction to rotation of the second position each includes a component of the fourth direction.

8. The recording apparatus according to claim 7, wherein
the recording unit is configured so that its position relative to a direction about its axis perpendicular to the opposing face, and relative to the fourth direction is adjusted by rotating the first position and the second position with a use of the first adjuster and the second adjuster, and
the apparatus further comprises a control unit configured to control an ejection timing of a liquid from ejection openings, based on position information of the ejection openings relative to a fifth direction parallel to the opposing face and perpendicular to the fourth direction.

9. The recording apparatus according to claim 7, wherein
the ejection opening array and at least another ejection opening array are aligned in a fifth direction parallel to the opposing face and perpendicular to the fourth direction, and
the first adjuster and the second adjuster are disposed in such a manner as to sandwich the ejection openings relative to the fifth direction.

10. The recording apparatus according to claim 1, further comprising at least another recording unit, wherein
the recording unit and said another recording unit are aligned in a sixth direction, the sixth direction being parallel to the opposing face and crossing a direction in which the recording units and the recording medium move relatively to each other at a time of recording an image on the recording medium,
in each of the recording units, a first direction which is a tangential direction to rotation of the first position and a second direction which is a tangential direction to rotation of the second position each includes a component of the sixth direction, and
the first adjuster and the second adjuster are provided for each of the recording units.

11. A method of adjusting a position of a recording unit in a recording apparatus, wherein
the recording apparatus includes:
a recording unit configured to record an image on a recording medium, which includes an opposing face to face the recording medium at a time of recording an image on the recording medium;
a first adjuster configured to rotate a first position and a second position different from the first position, about a first axis perpendicular to the opposing face, the first and second positions being defined on the recording unit; and
a second adjuster configured to rotate the first position and the second position about a second axis, different from the first axis, perpendicular to the opposing face,
the method comprises:
a first process of measuring a relative position which is a position of the recoding unit relative to a position where the recording unit should be disposed in the recording apparatus;
a second process of, after the first process, determining a target travel amount relative to a direction parallel to the opposing face of the recording unit, based on the relative position measured in the first process;
a third process of, after the first process, determining a first operation quantity which is an operation quantity of the first adjuster, and a second operation quantity which is an operation quantity of the second adjuster, based on the target travel amount determined in the second process; and
a fourth process of, after the third process, operating the first adjuster and the second adjuster based on the first operation quantity and the second operation quantity, to cause the recording unit to move in the direction parallel to the opposing face by the target travel amount.

12. The method according to claim 11, wherein
in the third process, the first operation quantity is determined based on an amount of travelling of the first position and that of the second position at a time of operating the first adjuster, and the second operation quantity is determined based on an amount of travelling of the first position and that of the second position at a time of operating the second adjuster.

13. The method according to claim 11, wherein
a first direction which is tangential direction to rotation of the first position about the first axis, and a second direction which is a tangential direction to rotation of the second position about the second axis each includes a component of direction parallel to the opposing face and perpendicular to a direction in which the recording unit and the recording medium move relatively to each other at a time of recording an image on the recording medium.

14. The method according to claim 11, wherein
in the recording apparatus,
where a third direction is a direction perpendicular to a line jointing the first position and the second position,
a is an amount of travelling of the first position in the third direction, caused by the first adjuster,
b is an amount of travelling of the second position in the third direction, caused by the first adjuster,
c is an amount of travelling of the first position in the third direction, caused by the second adjuster, and
d is an amount of travelling of the second position in the third direction, caused by the second adjuster,
ad−bc≠0.

15. The method according to claim 11, wherein
the first adjuster and the second adjuster each includes a cam which rotates about an axis perpendicular to the opposing face.

16. The method according to claim 15, wherein
the cam of the first adjuster and the cam of the second adjuster have the same structure and the same size.

17. The recording apparatus according to claim 15, wherein
a rotation center of the cam of the first adjuster corresponds to the second axis, and
a rotation center of the cam of the second adjuster corresponds to the first axis.

18. The method according to claim 11, wherein
the opposing face includes a plurality of ejection openings from which a liquid is ejected,
the ejection openings are aligned in a fourth direction parallel to the opposing face to structure an ejection opening array, and
a first direction which is a tangential direction to rotation of the first position, and a second direction which is a tangential direction to rotation of the second position each includes a component of the fourth direction.

19. The method according to claim 18, wherein
the recording unit is configured so that its position relative to a direction about its axis perpendicular to the opposing face, and relative to the fourth direction is adjusted by rotating the first position and the second position with a use of the first adjuster and the second adjuster, and
the apparatus further comprises a control unit configured to control an ejection timing of a liquid from ejection openings, based on position information of the ejection openings relative to a fifth direction parallel to the opposing face and perpendicular to the fourth direction.

20. The method according to claim 18, wherein
the ejection opening array and at least another ejection opening array are aligned in a fifth direction parallel to the opposing face and perpendicular to the fourth direction, and
the first adjuster and the second adjuster are disposed in such a manner as to sandwich the ejection openings relative to the fifth direction.

21. The method according to claim 11, wherein
the recording apparatus further includes at least another recording unit and the recording unit and said another recording unit are aligned in a sixth direction, the sixth direction being parallel to the opposing face and crossing a direction in which the recording units and the recording medium move relatively to each other at a time of recording an image on the recording medium,
in each of the reording units, a first direction which is a tangential direction to rotation of the first position and a second direction which is a tangential direction to rotation of the second position each includes a component of the sixth direction,
the first adjuster and the second adjuster are provided for each of the recording units, and
the first to fourth processes are performed for each of the recording units.
